(19) United States
(12) Patent Application Publication
(10) Pub. No.: US 2025/0362152 A1
(43) Pub. Date: Nov. 27, 2025

(54) DEVICE AND METHOD FOR PROVIDING DRIVING MAP

(71) Applicant: HL Klemove Corp., Incheon (KR)

(72) Inventor: Eunjong PYO, Incheon (KR)

(73) Assignee: HL Klemove Corp., Incheon (KR)

(21) Appl. No.: 18/929,721

(22) Filed: Oct. 29, 2024

(30) Foreign Application Priority Data
May 21, 2024 (KR) 10-2024-0065878

(51) Int. Cl. G01C 21/00; B60W 60/00; G01S 13/58; G01S 13/89

(52) U.S. Cl. CPC G01C 21/3841; G01S 13/58; G01S 13/89; B60W 60/001; B60W 2420/403; B60W 2420/408; B60W 2554/20; B60W 2554/4029; B60W 2556/40; B60W 2556/50

(57) ABSTRACT

The present embodiments may provide a device and method for providing a driving map which may generate a sub map based on a signal from a radar mounted to a vehicle and perform autonomous driving based on the sub map.

### CROSS-REFERENCE TO RELATED APPLICATION

This application claims priority from Korean Patent Application No. 10-2024-0065878, filed on May 21, 2024, which is hereby incorporated by reference for all purposes as if fully set forth herein.

### BACKGROUND

### Field

The present embodiments relate to a device and method capable of providing a driving map.

### Description of Related Art

As technology advances, vehicles are equipped with advanced technologies such as autonomous driving systems. In order to implement the autonomous driving system, precise information about surrounding objects and driving roads is required.

In general, an autonomous vehicle is controlled based on a precise map including detailed information about a road. Since the precise map contains a vast amount of information, it occupies a large storage volume. Accordingly, the precise map is stored in the precise map server and received through communication with the vehicle.

However, while the vehicle is autonomously driving, communication with the server may be cut off, and the vehicle may not be able to receive the precise map. Accordingly, there is a need for a detailed design of a technology capable of performing autonomous driving even when a vehicle may not receive a precise map.

### BRIEF SUMMARY

In the foregoing background, there may be provided a device and method for providing a driving map, which may generate a sub map for autonomous driving using a radar mounted to a vehicle.

In an aspect, the present embodiments may provide a driving map providing device comprising a point obtainer obtaining a radar point cloud based on a radar signal radiated from a radar mounted to a vehicle and reflected by an object, an updater updating a precise map received from a precise map server based on the radar point cloud, a sub map generator generating a sub map corresponding to road information to a predetermined point based on the radar point cloud when unable to receive the precise map from the precise map server, and a determiner determining a road where the vehicle is capable of autonomous driving based on the sub map.

In another aspect, the present embodiments may provide a driving map providing method comprising obtaining a radar point cloud based on a radar signal radiated from a radar mounted to a vehicle and reflected by an object, updating a precise map received from a precise map server based on the radar point cloud, generating a sub map corresponding to road information to a predetermined point based on the radar point cloud when unable to receive the precise map from the precise map server, and determining a road where the vehicle is capable of autonomous driving based on the sub map.

According to the present embodiments, there may be provided a device and method for providing a driving map which may generate a sub map based on a signal from a radar mounted to a vehicle and perform autonomous driving based on the sub map.

### DESCRIPTION OF DRAWINGS

The above and other objects, features, and advantages of the disclosure will be more clearly understood from the following detailed description, taken in conjunction with the accompanying drawings, in which:

FIG. 1 is a view illustrating a configuration of a driving map providing device according to the present embodiments;

FIG. 2 is a view illustrating a precise map server according to the present embodiments;

FIG. 3 is a view illustrating a method for differentiating a dynamic object and a static object according to the present embodiments;

FIGS. 4A and 4B are views illustrating updating a precise map according to the present embodiments;

FIG. 5 is a view illustrating a sub map according to the present embodiments;

FIG. 6 is a view illustrating a method for determining a drivable road according to the present embodiments;

FIG. 7 is a view illustrating a driving map providing method according to the present embodiments; and

FIG. 8 is a view illustrating a method for differentiating a static object and a dynamic object according to the present embodiments.

### DETAILED DESCRIPTION

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, a driving map providing device and a driving map providing method according to embodiments of the disclosure are described with reference to the related drawings.

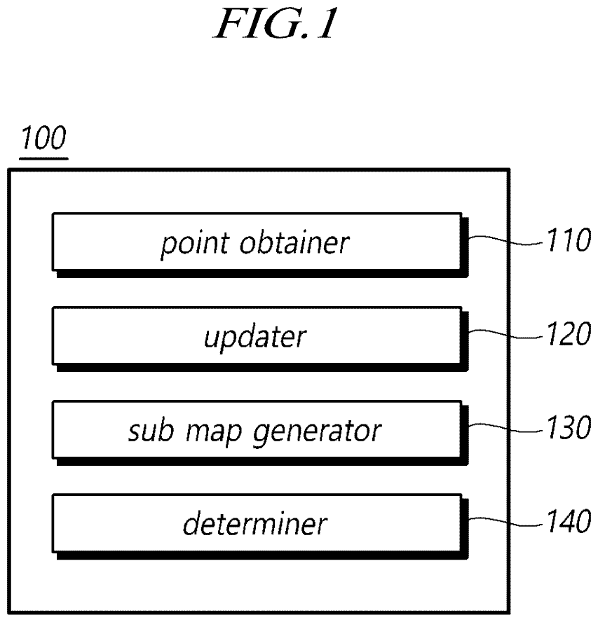

FIG. 1 is a view illustrating a configuration of a driving map providing device according to the present embodiments.

Referring to FIG. 1, a driving map providing device 100 may include a point obtainer 110 obtaining a radar point cloud based on a radar signal radiated from a radar mounted to a vehicle and reflected by an object, an updater 120 updating a precise map received from a precise map server based on the radar point cloud, a sub map generator 130 generating a sub map corresponding to road information to a predetermined point based on the radar point cloud when unable to receive the precise map from the precise map server, and a determiner 140 determining a road where the vehicle is capable of autonomous driving based on the sub map.

Referring back to FIG. 1, the point obtainer 110 may obtain a radar point cloud based on a radar signal radiated from a radar mounted to a vehicle and reflected from an object. For example, the point obtainer may obtain a radar point cloud based on a radar signal radiated from a radar mounted to a vehicle and reflected from an object. For example, the point obtainer may obtain a radar signal from a 4D radar mounted to the vehicle. The point obtainer may obtain a range, a Doppler, an azimuth, and an elevation of an object based on the obtained radar signal. Further, the point obtainer may receive driving information about the vehicle. The point obtainer may obtain driving information including the velocity, the steering angle, and the yaw rate of the vehicle.

The point obtainer 110 may obtain the radar point including the distance, the height, the depth, and the relative velocity for a portion of the object based on the radar signal and the driving information. Accordingly, the radar point may be displayed as three-dimensional (3D) coordinate information including relative velocity information. In other words, the radar point may be displayed as coordinate information having a value of (x, y, z).

Here, the object may include a static object including a road, a road surrounding structure, and a building, and a dynamic object including a surrounding vehicle and a person. The point obtainer 110 may differentiate the dynamic object from the static object based on coordinate information and velocity information about the point. According to an embodiment, the point obtainer 110 may generate at least one of a relative velocity vector map or a radar Doppler velocity vector map based on the radar point to differentiate the dynamic object and the static object. Accordingly, the point obtainer 110 may divide the obtained radar point into a dynamic object point and a static object point.

The point obtainer 110 may obtain a radar point cloud by clustering a plurality of radar points. The plurality of radar points generated by the same object may include similar information. Accordingly, the point obtainer 110 may cluster radar points having similar information.

The point obtainer 110 may recognize the object based on the obtained radar point cloud. In other words, the object may be recognized as a point cloud composed of a plurality of radar points. Accordingly, the dynamic object may be recognized as a dynamic object point cloud, and the static object may be recognized as a static object point cloud.

Referring back to FIG. 1, the updater 120 may update the precise map received from the precise map server based on the radar point cloud. In general, an autonomous vehicle is controlled based on a precise map including detailed information about a road. Since the precise map contains a vast amount of information, it occupies a large storage volume. Accordingly, the precise map is stored in the precise map server and received through communication with the vehicle.

When the vehicle receives the precise map from the precise map server, the updater 120 may update the received precise map based on the radar point cloud. The updater 120 may update the precise map by reflecting road information that may change in real time. For example, when a construction is underway on a driving road, road information according to the construction may not be reflected in the precise map. Accordingly, the updater 120 may perform an update operation of reflecting the road information recognized based on the static object point cloud to the precise map. The vehicle may perform autonomous driving based on the updated precise map.

Referring back to FIG. 1, the sub map generator 130 may generate a sub map based on the radar point cloud. When the vehicle may not receive the precise map from the precise map server, the sub map generator 130 may generate a sub map corresponding to the road information to a predetermined point based on the radar point cloud.

The sub map generator 130 may receive detection information from at least one sensor among a camera, an inertial measurement unit (IMU), and a GPS mounted to the vehicle. Here, the detection information obtained by each sensor may include static object information and dynamic object information. The sub map generator 130 may generate a sub map corresponding to road information to a predetermined point based on the static object point cloud and the detection information. The sub map generator 130 may generate a sub map corresponding to road information based on the static object point cloud.

The sub map generator 130 may refine the sub map based on the detection information obtained from each sensor. For example, the sub map generator 130 may refine the object information by accurately tracking the location and the moving direction of the vehicle based on the GPS detection information and the IMU detection information. Further, the sub map generator 130 may refine the object information by tracking the object by tracking between frames obtained by the camera based on the camera detection information and the IMU detection information. Here, a specific method in which the sub map generator 130 obtains object information based on the detection information and refines the object information follows the known art.

Referring back to FIG. 1, the determiner 140 may determine the road where the vehicle may drive based on the sub map. When the sub map generator 130 generates the sub map, the determiner 140 may determine the road where the vehicle may drive. In other words, the sub map may include information about the road where the vehicle may not drive and information about the road where the vehicle may drive. Accordingly, the determiner 140 may determine the road where the vehicle may drive and select the road where the vehicle may drive. A description related to a method for determining a road where the determiner 140 may drive is described below in detail with reference to the drawings.

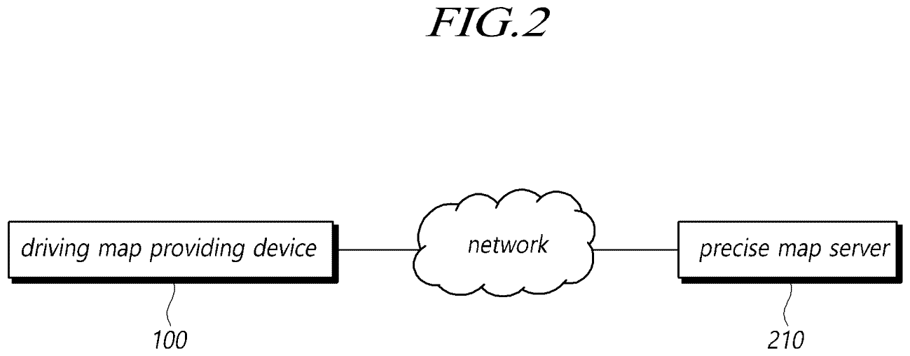

FIG. 2 is a view illustrating a precise map server according to the present embodiments.

Referring to FIG. 2, the driving map providing device 100 may receive a precise map from the precise map server 210. The precise map server 210 may transmit the precise map stored in the precise map server 210 to the vehicle through network communication. In general, the autonomous vehicle may be controlled based on a precise map including detailed road information. Since the precise map contains a vast amount of information, it may occupy a large storage volume. Accordingly, the precise map may be stored in the precise map server 210 and received through communication with the vehicle.

According to an embodiment, the vehicle may receive a precise map using vehicle to everything (V2X) communication. The precision map may be previously stored in surrounding vehicles, road surrounding infrastructure, pedestrian terminal devices, and the like. Accordingly, the vehicle may receive a precise map using vehicle-to-server, vehicle-to-vehicle, vehicle-to-infrastructure, and vehicle-to-pedestrian.

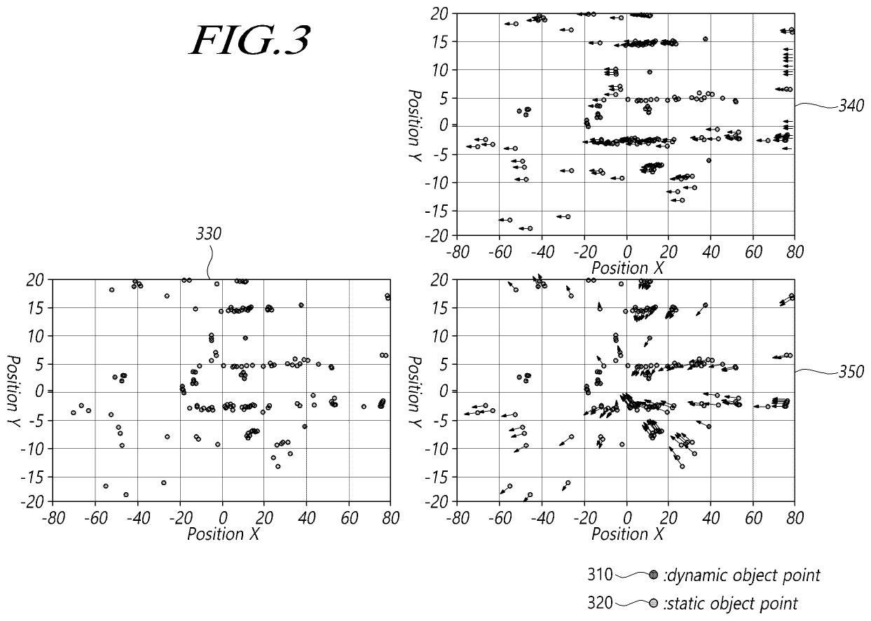

FIG. 3 is a view illustrating a method for differentiating a dynamic object and a static object according to the present embodiments.

The point obtainer may obtain a radar point cloud based on a radar signal radiated from a radar mounted to a vehicle and reflected from an object. For example, the point obtainer may obtain a radar signal from a 4D radar mounted to the vehicle. The point obtainer may obtain a range, a Doppler, an azimuth, and an elevation of an object based on the obtained radar signal. Further, the point obtainer may receive driving information about the vehicle. The point obtainer may obtain driving information including the velocity, the steering angle, and the yaw rate of the vehicle.

The point obtainer may obtain the radar point including the distance, the height, the depth, and the relative velocity for a portion of the object based on the radar signal and the driving information. Accordingly, the radar point may be displayed as three-dimensional (3D) coordinate information including relative velocity information. In other words, the radar point may be displayed as coordinate information having a value of (x, y, z).

Here, the object may include a static object including a road, a road surrounding structure, and a building, and a dynamic object including a surrounding vehicle and a person. The point obtainer may differentiate the dynamic object from the static object based on coordinate information and velocity information about the point. According to an embodiment, the point obtainer may generate at least one of a relative velocity vector map or a radar Doppler velocity vector map based on the radar point to differentiate the dynamic object and the static object. Accordingly, the point obtainer may divide the obtained radar point into a dynamic object point 310 and a static object point 320.

As illustrated in FIG. 3, the radar point may be displayed on a radar point location map 330. Here, the radar point location map 330 is a diagram for describing a relative velocity vector map 340 and a Doppler velocity vector map 350.

Referring to the radar point location map 330 according to an embodiment, the dynamic object point 310 and the static object point 320 may be displayed as coordinate points 310 and 320 having a value (x,y). Here, the radar point location map 330 may be displayed as a graph indicating location information in which the horizontal axis corresponds to the x value and location information in which the vertical axis corresponds to the y value. The point obtainer may obtain the relative velocity vector map 340 and the radar Doppler velocity vector map 350 corresponding to each coordinate point 310 and 320.

The point obtainer may obtain the relative velocity vector map 340 and the radar Doppler velocity vector map 350 based on the dynamic object point 310 and the static object point 320. The dynamic object point 310 and the static object point 320 may be displayed as different relative velocity vectors and radar Doppler velocity vectors.

Referring to FIG. 3, each radar point may include a relative velocity and a Doppler velocity. For example, since the static object is a motionless object, the static object may have the same relative velocity as the velocity of the vehicle. Referring to the relative velocity vector map 340, the static object point 320 may be opposite to the driving direction of the vehicle based on the relative velocity and may be indicated by an arrow having the same shape as the velocity of the vehicle. Accordingly, the point obtainer may differentiate the static object point 320 and the dynamic object point 310 based on the relative velocity map.

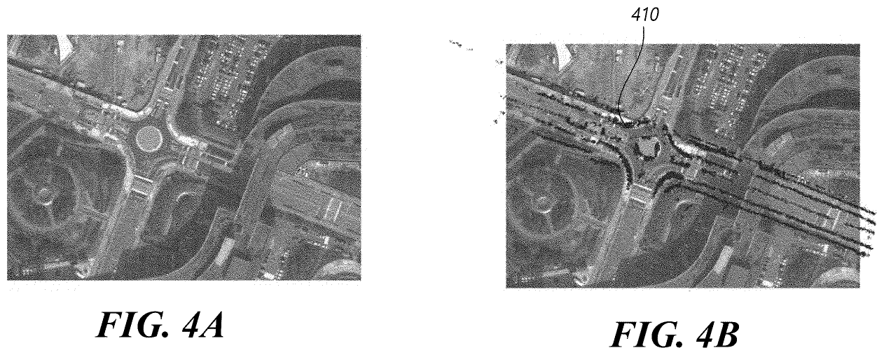

FIGS. 4A and 4B are views illustrating updating a precise map according to the present embodiments.

FIG. 4A is a view illustrating road information included in a precise map according to an example. FIG. 4B is a view illustrating road information obtained based on a radar point cloud 410. The precise map may include information a about the road where the vehicle is driving. The point obtainer may obtain a radar point cloud 410 for the information a where the vehicle is driving. The updater may obtain real-time road information b based on the radar point cloud 410. The updater may update the road information a about the precise map received from the precise map server, based on the real-time road information b obtained based on the radar point cloud 410.

For example, when a construction is underway on a driving road, road information b according to the construction may not be reflected to the road information a of the precise map. Accordingly, the updater may perform an update operation of reflecting the road information b recognized based on the static object point cloud 410 to the road information a of the precise map. The vehicle may perform autonomous driving based on the updated precise map.

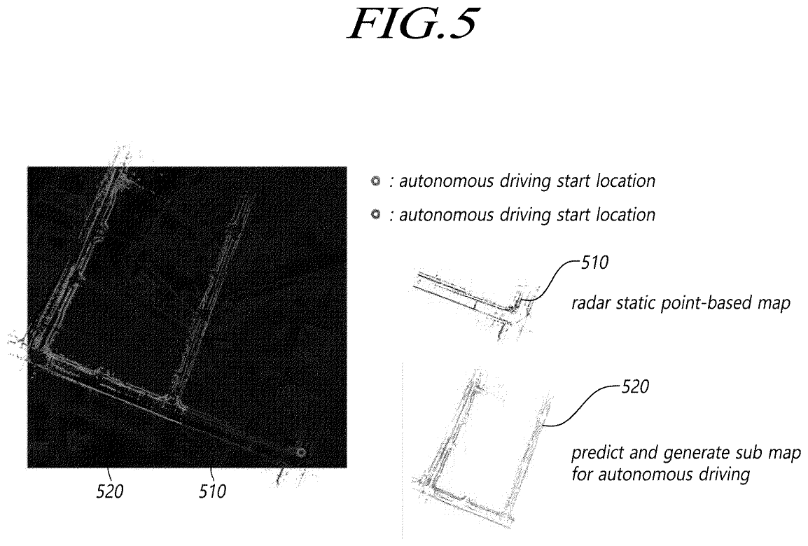

FIG. 5 is a view illustrating a sub map according to the present embodiments.

Referring to FIG. 5, the sub map generator may generate the sub map 510 based on the radar point cloud. When the vehicle may not receive the precise map from the precise map server, the sub map generator may generate a sub map 510 corresponding to the road information to a predetermined point based on the radar point cloud. Here, the predetermined point may be a point set as a destination of autonomous driving.

Referring back to FIG. 5, the sub map generator may receive detection information from at least one sensor among a camera, an inertial measurement unit (IMU), and a GPS mounted to the vehicle. Here, the detection information obtained by each sensor may include static object information and dynamic object information. The sub map generator may generate a sub map 520 corresponding to road information to a predetermined point based on the static object point cloud and the detection information.

Specifically, the sub map generator may predict road information to a point set as a destination based on detection information obtained from at least one sensor. The sub map generator may generate the sub map 520 by reflecting the road information obtained based on the static object point cloud to the predicted road information.

For example, the sub map generator may receive the map from the GPS to the destination, and generate the sub map by specifying the road information about the received map based on the static object point cloud and the camera detection information.

Further, while the vehicle is driving based on the sub map 520, the updater may obtain road information based on the radar point cloud. The updater may update the sub map received from the sub map generator based on the obtained road information. In other words, the updater may reflect the road information obtained based on the radar point cloud in the sub map.

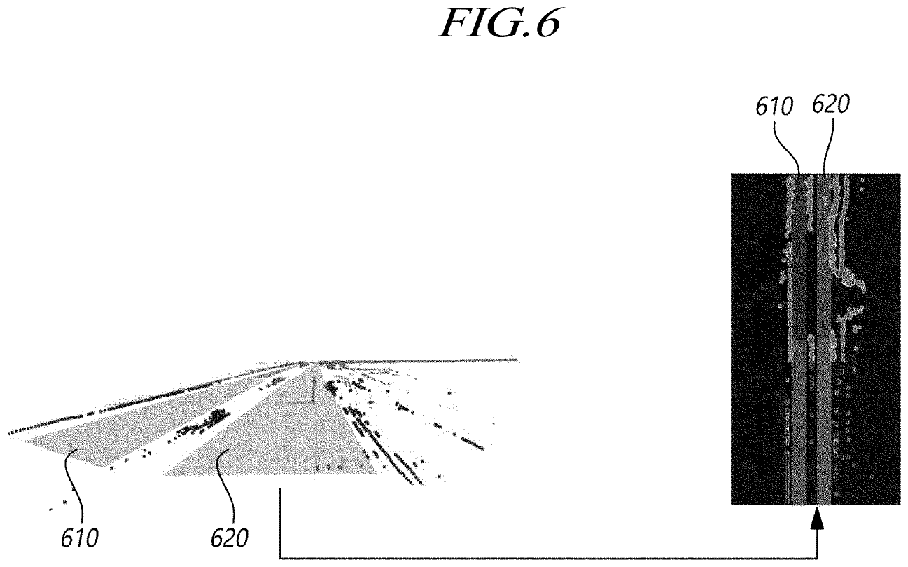

FIG. 6 is a view illustrating a method for determining a drivable road according to the present embodiments.

The determiner may determine the road where the vehicle may drive based on the sub map. As illustrated in FIG. 6, when the sub map generator generates a sub map for a two-lane road, the sub map may include road information 620 in the driving direction of the vehicle and road information 610 in the reverse direction.

The determiner may determine road information 620 in the same direction as the driving direction of the vehicle. For example, the determiner may determine the direction of the road based on the dynamic object point cloud. The determiner may obtain the relative velocity of the surrounding vehicle based on the dynamic object point cloud and determine the direction of the road. In other words, the determiner may determine the direction of the road by comparing the relative velocity of the vehicle driving on the road 620 in the same direction with the relative velocity of the vehicle driving on the road 610 in the reverse direction. However, the above description is merely an example for the determiner to determine the road where the vehicle may drive, and is not limited thereto. The method for the determiner to determine a drivable road may be configured variously as necessary unless contradictory to the technical spirit of the disclosure.

Accordingly, it is possible to provide a driving map providing device capable of updating a precise map received from a precise map server based on a signal from a radar mounted to a vehicle. It is also possible to provide a driving map providing device that generates a sub map capable of performing autonomous driving based on a signal from a radar mounted to a vehicle even when the vehicle is unable to receive a precise map.

Hereinafter, a driving map providing method capable of performing some or all of the embodiments described with reference to FIGS. 1 to 6 is described with reference to the drawings. The above-described description may be omitted to avoid redundant description and, in that case, the omitted content may be applied in substantially the same manner to the following description as long as it does not go against the technical spirit of the disclosure.

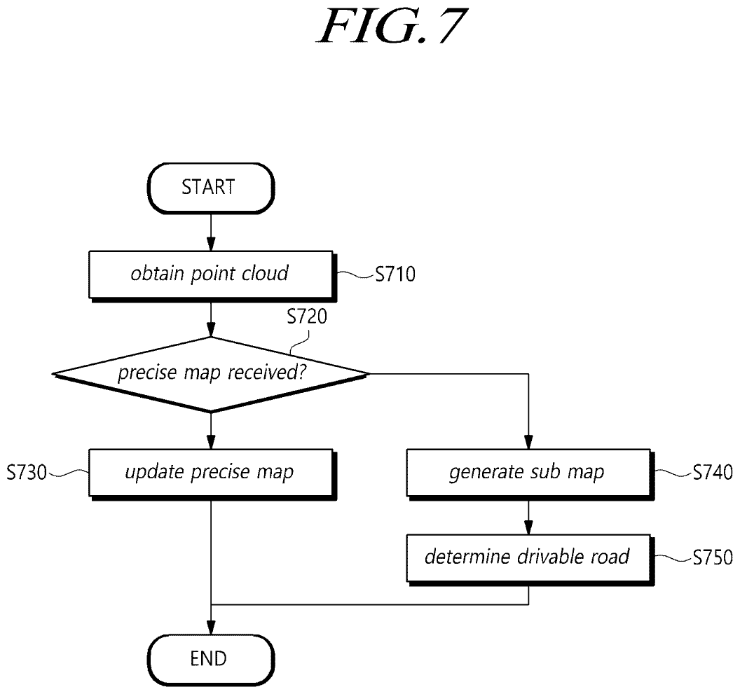

FIG. 7 is a view illustrating a driving map providing method according to the present embodiments.

Referring to FIG. 7, the driving map providing device may obtain a radar point cloud based on a radar signal radiated from a radar mounted to a vehicle and reflected by an object (S710).

The driving map providing device may obtain a radar point cloud based on a radar signal radiated from a radar mounted to a vehicle and reflected from an object. For example, the driving map providing device may obtain a radar signal from a 4D radar mounted to the vehicle. The driving map providing device may obtain a range, a Doppler, an azimuth, and an elevation of an object based on the obtained radar signal. Further, the driving map providing device may receive driving information about the vehicle. The driving map providing device may obtain driving information including the velocity, the steering angle, and the yaw rate of the vehicle.

The driving map providing device may obtain the radar point including the distance, the height, the depth, and the relative velocity for a portion of the object based on the radar signal and the driving information. Accordingly, the radar point may be displayed as three-dimensional (3D) coordinate information including relative velocity information. In other words, the radar point may be displayed as coordinate information having a value of (x, y, z).

Here, the object may include a static object including a road, a road surrounding structure, and a building, and a dynamic object including a surrounding vehicle and a person. The driving map providing device may differentiate the dynamic object from the static object based on coordinate information and velocity information about the point. According to an embodiment, the driving map providing device may generate at least one of a relative velocity vector map or a radar Doppler velocity vector map based on the radar point to differentiate the dynamic object and the static object. Accordingly, the driving map providing device may divide the obtained radar point into a dynamic object point and a static object point.

The driving map providing device may obtain a radar point cloud by clustering a plurality of radar points. The plurality of radar points generated by the same object may include similar information. Accordingly, the driving map providing device may cluster radar points having similar information.

The driving map providing device may obtain a radar point cloud by clustering a plurality of radar points. Accordingly, the object may be recognized as a point cloud composed of a plurality of radar points. In other words, the dynamic object may be recognized as a dynamic object point cloud, and the static object may be recognized as a static object point cloud.

Referring back to FIG. 7, the driving map providing device may update the precise map (S720) received from the precise map server based on the radar point cloud (S730).

The driving map providing device may update the precise map received from the precise map server based on the radar point cloud. In general, an autonomous vehicle is controlled based on a precise map including detailed information about a road. Since the precise map contains a vast amount of information, it occupies a large storage volume. Accordingly, the precise map is stored in the precise map server and received through communication with the vehicle.

When the vehicle receives the precise map from the precise map server (S720), the driving map providing device may update the received precise map based on the radar point cloud. The driving map providing device may update the precise map by reflecting road information that may change in real time. For example, when a construction is underway on a driving road, road information according to the construction may not be reflected in the precise map. Accordingly, the driving map providing device may perform an update operation of reflecting the road information recognized based on the static object point cloud to the precise map. The vehicle may perform autonomous driving based on the updated precise map.

Referring back to FIG. 7, the driving map providing device, when unable to receive the precise map from the precise map server (S720), may generate a sub map corresponding to road information to a predetermined point based on the radar point cloud (S740).

The driving map providing device may generate a sub map based on the radar point cloud. When the vehicle may not receive the precise map from the precise map server, the driving map providing device may generate a sub map corresponding to the road information to a predetermined point based on the radar point cloud.

The driving map providing device may receive detection information from at least one sensor among a camera, an inertial measurement unit (IMU), and a GPS mounted to the vehicle. Here, the detection information obtained by each sensor may include static object information and dynamic object information. The driving map providing device may generate a sub map corresponding to road information to a predetermined point based on the static object point cloud and the detection information. The driving map providing device may generate a sub map corresponding to road information based on the static object point cloud.

The driving map providing device may refine the sub map based on the detection information obtained from each sensor. For example, the driving map providing device may refine the object information by accurately tracking the location and the moving direction of the vehicle based on the GPS detection information and the IMU detection information. Further, the driving map providing device may refine the object information by tracking the object by tracking between frames obtained by the camera based on the camera detection information and the IMU detection information. Here, a specific method in which the driving map providing device obtains object information based on the detection information and refines the object information follows the known art.

Referring back to FIG. 7, the driving map providing device may determine the road where the vehicle is capable of autonomous driving based on the sub map (S750).

The driving map providing device may determine the road where the vehicle may drive based on the sub map. When the sub map generator generates the sub map, the driving map providing device may determine the road where the vehicle may drive. In other words, the sub map may include information about the road where the vehicle may not drive and information about the road where the vehicle may drive. Accordingly, the driving map providing device may determine the road where the vehicle may drive and select the road where the vehicle may drive.

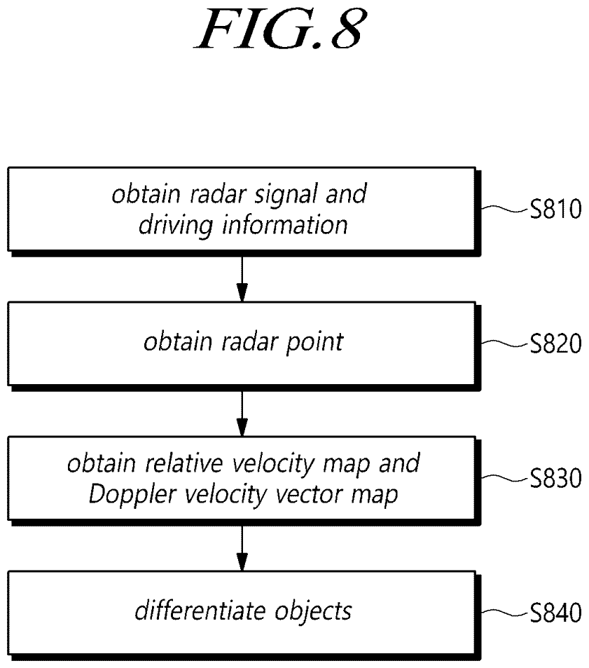

FIG. 8 is a view illustrating a method for differentiating a static object and a dynamic object according to the present embodiments.

The driving map providing device may obtain a radar point cloud based on a radar signal radiated from a radar mounted to a vehicle and reflected from an object. For example, the driving map providing device may obtain a radar signal from a 4D radar mounted to the vehicle (S810). The driving map providing device may obtain a range, a Doppler, an azimuth, and an elevation of an object based on the obtained radar signal. Further, the driving map providing device may receive driving information about the vehicle (S810). The driving map providing device may obtain driving information including the velocity, the steering angle, and the yaw rate of the vehicle.

The driving map providing device may obtain the radar point including the distance, the height, the depth, and the relative velocity for a portion of the object based on the radar signal and the driving information (S820). Accordingly, the radar point may be displayed as three-dimensional (3D) coordinate information including relative velocity information. In other words, the radar point may be displayed as coordinate information having a value of (x, y, z).

Here, the object may include a static object including a road, a road surrounding structure, and a building, and a dynamic object including a surrounding vehicle and a person. The driving map providing device may differentiate the dynamic object from the static object based on coordinate information and velocity information about the point. According to an embodiment, the driving map providing device may generate (S830) at least one of a relative velocity vector map or a radar Doppler velocity vector map based on the radar point to differentiate (S840) the dynamic object and the static object. Accordingly, the driving map providing device may divide the obtained radar point into a dynamic object point and a static object point.

Accordingly, it is possible to provide a driving map providing method capable of updating a precise map received from a precise map server based on a signal from a radar mounted to a vehicle. It is also possible to provide a driving map providing method that generates a sub map capable of performing autonomous driving based on a signal from a radar mounted to a vehicle even when the vehicle is unable to receive a precise map.

What is claimed is:

1. A driving map providing device, comprising:
a point obtainer obtaining a radar point cloud based on a radar signal radiated from a radar mounted to a vehicle and reflected by an object;
an updater updating a precise map received from a precise map server based on the radar point cloud;
a sub map generator generating a sub map corresponding to road information to a predetermined point based on the radar point cloud when unable to receive the precise map from the precise map server; and
a determiner determining a road where the vehicle is capable of autonomous driving based on the sub map.

2. The driving map providing device of claim 1, wherein the radar point corresponds to the object and includes three-dimensional (3D) coordinate information and velocity information, and wherein the radar point cloud is obtained by clustering a plurality of radar points.

3. The driving map providing device of claim 1, wherein the object includes a static object including a road, a road surrounding structure, and a building, and a dynamic object including a surrounding vehicle and a person.

4. The driving map providing device of claim 3, wherein the point obtainer generates at least one of a relative velocity vector map or a radar Doppler velocity vector map based on the radar point to differentiate the dynamic object and the static object.

5. The driving map providing device of claim 4, wherein the updater updates the precise map based on a point corresponding to the static object.

6. The driving map providing device of claim 4, wherein the sub map generator generates the sub map based on a point corresponding to the static object.

7. The driving map providing device of claim 1, wherein the sub map generator generates the sub map by receiving detection information from at least one sensor among a camera, an inertial measurement unit (IMU), and a global positioning system (GPS) mounted to the vehicle and further reflecting the detection information.

8. A driving map providing method, comprising:
obtaining a radar point cloud based on a radar signal radiated from a radar mounted to a vehicle and reflected by an object;
updating a precise map received from a precise map server based on the radar point cloud;
generating a sub map corresponding to road information to a predetermined point based on the radar point cloud when unable to receive the precise map from the precise map server; and
determining a road where the vehicle is capable of autonomous driving based on the sub map.

9. The driving map providing method of claim 8, wherein the radar point corresponds to the object and includes three-dimensional (3D) coordinate information and velocity information, and wherein the radar point cloud is obtained by clustering a plurality of radar points.

10. The driving map providing method of claim 8, wherein the object includes a static object including a road, a road surrounding structure, and a building, and a dynamic object including a surrounding vehicle and a person.

11. The driving map providing method of claim 10, wherein obtaining the radar point cloud generates at least one of a relative velocity vector map or a radar Doppler velocity vector map based on the radar point to differentiate the dynamic object and the static object.

12. The driving map providing method of claim 11, wherein updating the precise map updates the precise map based on a point corresponding to the static object.

13. The driving map providing method of claim 11, wherein generating the sub map generates the sub map based on a point corresponding to the static object.

14. The driving map providing method of claim 8, wherein generating the sub map generates the sub map by receiving detection information from at least one sensor among a camera, an inertial measurement unit (IMU), and a global positioning system (GPS) mounted to the vehicle and further reflecting the detection information.
